(19) United States
(12) Patent Application Publication
(10) Pub. No.: US 2007/0278158 A1
(43) Pub. Date: Dec. 6, 2007

(54) WASTEWATER TREATMENT SYSTEM AND METHOD

(75) Inventor: GURUNATHAN LAKSHMAN, Saskatoon (CA)

Correspondence Address: DLA PIPER US LLP, P. O. BOX 9271, RESTON, VA, 20195, US

(73) Assignee: GREEN SHELTER INNOVATIONS LIMITED, Nicosia (CY)

(21) Appl. No.: 11/756,009

(22) Filed: May 31, 2007

Related U.S. Application Data
(60) Provisional application No. 60/803,667, filed on Jun. 1, 2006.

(51) Int. Cl. C02F 9/00; B03D 3/06; C02F 9/02; C02F 9/04; C02F 9/08

(52) U.S. Cl. 210/704; 210/151; 210/199

(57) ABSTRACT

The sewage treatment system of the present invention comprises at least three reaction tanks, a solid separator, and an upflow reactor or a filter. The first reaction tank elevates pH of the sewage, more than 10.0; the second reaction tank induces rapid flocculation of the sewage from the first reaction tank to remove all suspended solids, insoluble BOD, insoluble chemical complexes by using polymeric flocculent and/or coagulant; the solid separator separates the flocculated waste matter and solids, discharged from the second reaction tank, the upflow reactor or the filter adsorbs dissolved organic compounds including gases and/or to moderate the pH of the contents from the solid separator and the third reaction tank reduces the pH of the contents from the upflow reactor or the filter to acceptable levels of 8.5. The invention also discloses a process for treating sewage to obtain a treated sewage for various applications.

This application claims benefit of priority from U.S. Provisional Application Ser. No. 60/803,667 filed on Jun. 1, 2006. The entire teachings of these applications are incorporated herein by reference.

### FIELD OF INVENTION

The present invention in general relates to a sewage treatment system for treatment of waste fluid. The present invention particularly relates to a treatment system and method for treating sewage, industrial and agricultural wastewaters and produce recyclable, odor-free and bacteria-free water, nutrient-rich sludge and mitigate the production of greenhouse gases.

### BACKGROUND

Sewage treatment is the process of removing contaminants from sewage. It includes physical, chemical and biological processes to remove physical, chemical and biological contaminants. The objective of sewage treatment is to produce a wastestream (or treated effluent) and a solid waste or sludge suitable for reuse or discharge back into the environment. The waste material is often inadvertently contaminated with toxic organic and inorganic compounds.

Sewage is created by residences, institutions, and commercial and industrial establishments. It can be treated close to where it is created (in septic tanks or onsite package plants and other aerobic treatment systems), or collected and transported via a network of pipes and pump stations to a municipal treatment plant. Industrial sources of wastewater often require specialized treatment processes.

There exists a need for using non-toxic and non-hazardous chemicals to bring about the treatment of sewage. The residues of these non-toxic and non-hazardous chemicals in the treated water or sludge add important benefits to the soil and crops. Further, it is desired that the cost of treatment process be low compared to the conventional treatment technologies. There is need to kill all bacteria without using any disinfectant chemical and is desired that the treated water be devoid of detectable E. coli and other coliforms. It is desirable that the method of treatment of sewage should be effective in destroying all odor-causing bacteria.

### SUMMARY OF THE INVENTION

Accordingly, a sewage treatment system and process for treating sewage is described. The system of the present invention comprises at least three reaction tanks, a solid separator, and an upflow reactor or a filter. The first reaction tank elevates pH of the sewage, more than 10.0. The second reaction tank induces rapid flocculation of the output from the first reaction tank to remove all suspended solids, insoluble BOD (Biochemical (biological) oxygen demand), insoluble chemical complexes by using polymeric flocculent and/or coagulant. The solid separator separates the flocculated waste matter and solids discharged from the second reaction tank. The upflow reactor adsorbs dissolved organic compounds including gases and/or to moderate the pH of the contents from the solid separator. The third reaction tank reduces the pH of the contents from the upflow reactor to acceptable levels of 8.5 or less. In cases where higher pH of water is permitted, water with high pH can be discharged directly without being treated to reduce its pH. If the oxygen level is low additional oxygen added using aeration.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 shows sewage treatment system embodying the present invention

FIG. 2 shows structures of chemical tanks, storage tank and reaction tanks embodying the present invention

FIG. 3 shows structures of solid separator, collection tank 1 and upflow reactor or a filter embodying the present invention

FIG. 4 shows structure of final collection tank embodying the present invention

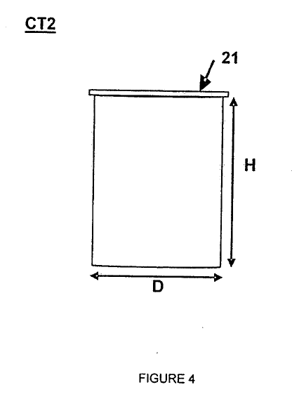

### DRAWINGS-REFERENCE LETTERS AND NUMERALS

C1-chemical tank 1
C2-chemical tank 2
C3—chemical tank 3
ST1—raw sewage storage tank
R1—reaction tank 1 (two in number)
R2—reaction tank 2
R3—reaction tank 3
SS—solid separator
SD—solid discharge
CT1—storage tank
CT2—final collection tank for the treated water before discharge
CH1—calcium hydroxide (hydrated lime) or equivalent chemical.
CH2—polymeric flocculent and/or coagulant or other equivalent chemical.
CH3—aluminum sulphate (alum) or equivalent chemical.
P1, P2, P3, P4—transfer pumps
SW1, SW2, SW3—switching device
PV1, PV2—pinch valves
CL—an upflow reactor or a filter
M1, M2, M3, M4—mixers in the reaction tanks
H, H1, H2, H3, H4, H5—heights
D, D1, D2, D3, D4, D5—diameters
21—Removable cover
22—Removable cover with cut out for the mixer

### DETAILED DESCRIPTION

Accordingly, the present invention provides a sewage treatment system comprising of at least one first reaction tank for elevating pH of the sewage to more than 10.0; a second reaction tank for inducing rapid flocculation of the output from the first reaction tank to remove all suspended solids, insoluble BOD, insoluble chemical complexes by using polymeric flocculent and/or coagulant; a solid separator, separating the flocculated waste matter and solids discharged from the second reaction tank; an upflow reactor or a filter for adsorbing dissolved organic compounds including gases and/or moderate the pH of the contents from the solid separator; and a third reaction tank to reduce the pH of the contents from the upflow reactor or the filter to acceptable levels of 8.5 or less to obtain clear treated sewage. In cases where higher pH of water is permitted, water with high pH can be discharged directly without being treated to reduce its pH. If the oxygen level is low additional oxygen added using aeration.

Another aspect of the invention provides a method of treating sewage comprising increasing the pH of the sewage to more than 10, inducing rapid flocculation by adding polymeric flocculent and/or coagulant followed by removing all suspended solids, insoluble BOD and insoluble chemical complexes; separating the flocculated matter and solids from the above; adsorbing excess organic compounds and/or moderating the pH of the contents by using a filter, and reducing the pH of the above to acceptable levels of 8.5 or less by adding to obtain treated water for various applications.

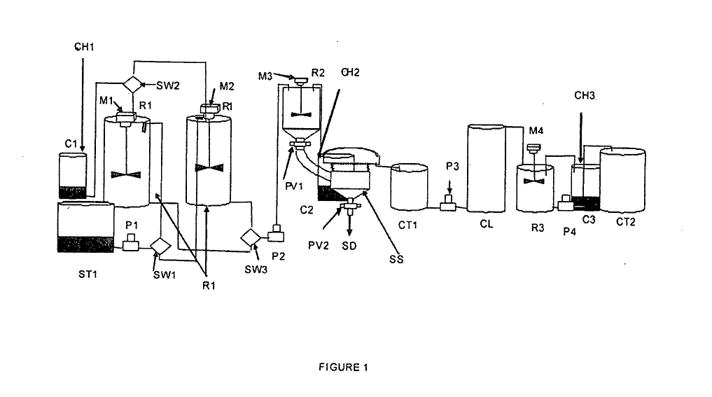

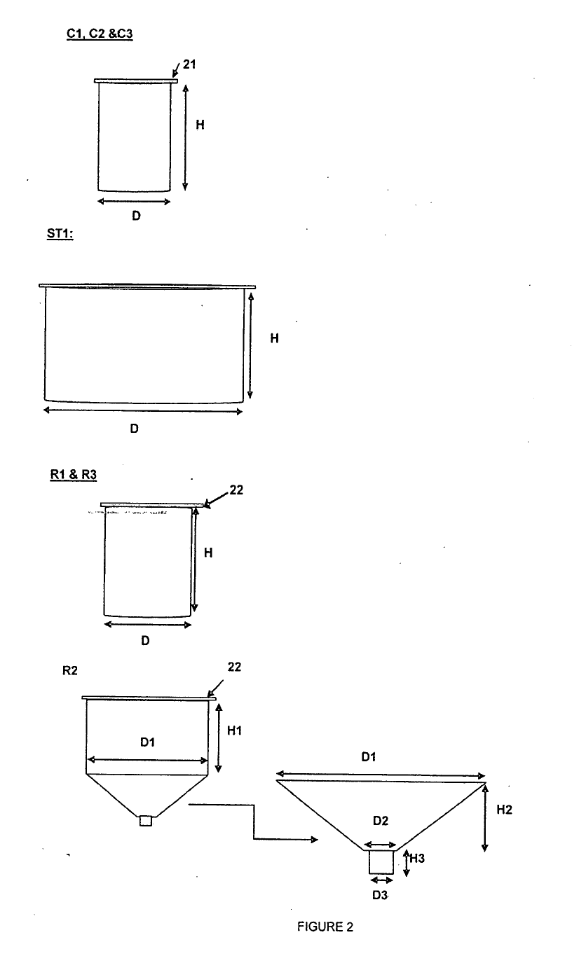

FIG. 1 shows a sewage treatment system embodying present invention. In one embodiment, sewage from domestic, municipal, industrial, and agricultural sources, is pumped from main supply line to storage tank ST1. In one embodiment as shown in FIG. 2 the storage tank ST1 is of cylindrical shape having diameter D and height H. The storage tank ST1 functions as equalization tank to equalize the pH of dissolved and suspended solids and generates a homogenous sewage for the treatment. In one embodiment the storage tank ST1 is intended to provide storage only for a few hours.

The sewage is then pumped to two reaction tanks R1 one after another. In one embodiment as shown in FIG. 1 pump P1 is used to pump the sewage from the storage tank ST1 to the two reaction tanks R1. In one embodiment as shown in FIG. 1 a switching device SW1 is used to pump the sewage from the storage tank ST1 to the two reaction tanks R1 one after another. In another embodiment as shown in FIG. 2 the reaction tanks R1 is of cylindrical shape with removable cover 22 with cut out for the mixer. First reaction in the tank R1 can be longer than second reaction in a reaction tank R2 depending upon nature of sewage, so there are the two tanks R1 for the first reaction to ensure that the flow to the second reaction tank R2 takes place without interruption or delay. In another embodiment there can be one or more than two reaction tanks R1 to ensure the flow to the second reaction tank R2 takes place without interruption or delay. Once the reaction tanks R1 are filled to predetermined level chemical CH1 is fed in the tanks R1. In one embodiment the chemical CH1 is stored in a chemical tank C1 as shown in FIG. 1.

In one embodiment the chemical CH1 is calcium hydroxide (hydrated lime) or equivalent chemical. The chemical CH1 is used to elevate the pH of the sewage more than 10 and produce insoluble chemical complexes consisting of various hydroxides. The lime also activates initial flocculation. In most sewage when the pH is raised to this high value flocculation begin to form, although the degree of flocculation and density of flocculation depends upon chemical composition of the sewage. The chemical CH1 is used to produce complexation and precipitation of calcium-nitrogen-phosphorous complexes and act as a very efficient bactericide. Most bacteria do not survive in highly alkaline environments such as those with pH 10.0 and above.

In one embodiment a switching device SW2 is used for switching of the chemical CH1 between the tanks R1. In one embodiment mixers M1 and M2 is used to provide rapid agitation at about 400 rpm for about 7-10 minutes. Although in the present embodiment contents in the reaction tanks R1 is agitated at about 400 rpm, the invention is not limited to this particular rpm. The rpm depend on among other parameters on amount of the sewage, type of the sewage, strength and pH of the sewage, size of the tank R1, and capacity of the mixers M1 and M2. Similarly, in the present embodiment contents in the reaction tank R1 is agitated for about 7-10 minutes, the invention is not limited to this particular time limit. The time limit depends, on among other parameters, on the amount of the sewage, type of the sewage, strength and pH of the sewage, size of the tank R1, and capacity of the mixers M1 and M2.

Once the sewage in the reaction tank R1 reaches specified pH value of above 10, depending on the nature of the sewage, it is then pumped to the reaction tank R2. In one embodiment structure of the reaction tank R2 is as shown in FIG. 2. In one embodiment as shown in FIG. 1 a pump P2 is used to pump the sewage from the two reaction tanks R1 to the reaction tank R2. In one embodiment as shown in FIG. 1, a switching device SW3 is sued to pump the sewage one after another from the two reaction tanks R1 to the reaction tank R2. Second chemical CH2 is then fed into the reaction tank R2. The chemical CH2 is a cationic polymer consisting of high molecular weight polyacrylamide such as C-496 manufactured by CYTEC. Any of the polymers that are cationic, anionic and non-ionic in nature can be used for this purpose. These polymers include all varieties manufactured for the purpose of including flocculation (as flocculants) and coagulation by manufacturers such as CYTEC, Betts Dearborn, SNF and others.

The chemical CH2 induces rapid flocculation at high pH values of around 12.0 and remove all suspended solids, insoluble BOD, and all other insoluble complexes. In one embodiment as shown in FIG. 1 a mixer M3 is used to mix the sewage and the chemical CH2 to induce rapid flocculation. In one embodiment the chemical CH2 is dosed into the reaction tank R2 within a minute and at a mixing speed of around 400 rpm for one minute and the speed is reduced to about 130 rpm for another minute and then contents are allowed to settle for about 7 minutes. There can be other mixing speeds which can be employed for other time durations to achieve the same final result. This variation in the duration and speed of mixing can be changed depending, among other parameters, on amount of the sewage, type of the sewage, strength and pH of the sewage, size of the tank R2, and capacity of the mixtures M3. Once the maximum flocculation density is achieved, the sewage is allowed to settle. The flocculation is then allowed to coagulate and settle to the bottom.

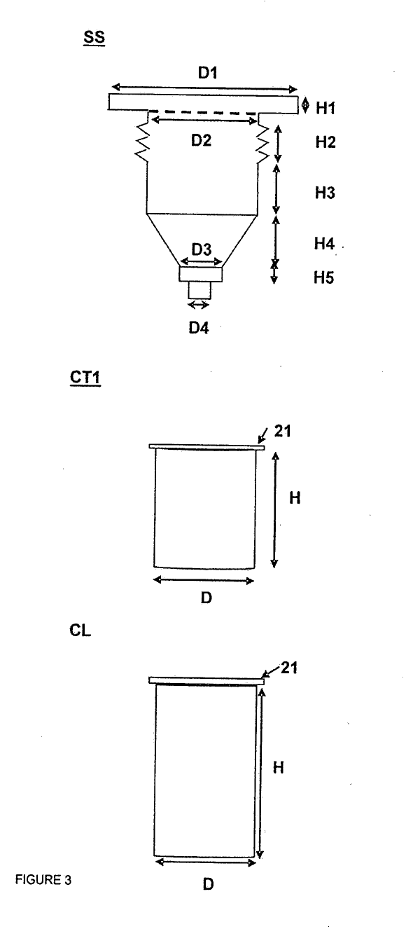

The sewage with dense flocculation settle to bottom of the reaction tank R2 and is then discharged to a solid separator SS by gravity. In one embodiment structure of the solid separator is as shown in FIG. 3. In one embodiment a pinch valve PV1 is used to control the flow of sewage from the reaction tank R2 to the solid separator SS as shown in FIG. 1. In one embodiment the pinch valve PV1 is electrically operated. Heights of the reaction tank R2 and the solid separator SS should be adjusted to ensure that the flow from the reaction tank R2 feeds into the solid separator SS by gravity without loss of head. Top of the solids separator SS should be below bottom line of the discharge from the reaction tank R2. In one embodiment the solid separator SS functions without any motors and pumps. As inside volume of the solid separator SS gets filled up, the sewage level rises gradually and exits. In the solid separator SS solids settle to bottom while the clear water exits from the top. In one embodiment as shown in FIG. 1 a pinch valve PV2 is used to control flow of solid discharge SD settled to bottom of the solid separator SS. In one embodiment the pinch valve PV2 is electrically operated. The clear water then drains by gravity to a storage tank CT1.

The treated sewage collected in the storage tank CT1 is then pumped to an upflow reactor or a filter CL. In one embodiment a pump P3 is used for pumping the treated sewage from the storage tank CT1 to the filter CL. The filter CL contains activated carbon and/or zeolite as filtering media. The activated carbon can be any coconut shell or bitumen coal carbon with specific properties with high adsorption characteristics in terms of iodine number, carbon tetrachloride activity, specific surface area and methylene blue number. In one embodiment the sewage enters the filter CL from bottom and exits through top. In another embodiment the sewage enters the filter CL from the top and exits through the bottom. Purpose of the activated carbon and zeolite filter is to absorb excess organic compounds introduced by the polymer and odor-causing chemicals. The filter CL adsorbs dissolved organic compounds including gases and/or moderates the pH of the sewage. The filter also moderates the pH of the sewage.

The clear water exiting the filter Cl enters a reaction tank R3. Chemical CH3 is dosed into the reaction tank R3. In one embodiment as shown in FIG. 1 the chemical CH3 is stored in chemical tank C3. In one embodiment as shown in FIG. 1 mixer M4 is used for mixing contents in the reaction tank R3. In another embodiment the mixer M3 in the reaction tank R3 mixes the contents for about 3 minute at about 400 rpm. The duration and speed of mixing may be changed depend on among other parameters on amount of the sewage, type of the sewage, strength and pH of the sewage, size of the tank R3, and capacity of the mixtures M3. In one embodiment the chemical CH3 is aluminum sulphate, commonly known as alum. Water of hydration may vary depending on the chemical grade of the alum used. Since all flocs have already been removed, clear water with little or no suspended solids is produced. The alum is used to reduce the pH of the water to acceptable levels of 8.5 or less. But depending upon the nature and source of the sewage, function of alum changes and includes other aspects such as flocculation, odor-removal, color-removal, etc. The functional importance of alum is not restricted to any one aspect of its treatment capabilities.

Further, in one embodiment the fully treated water is then pumped by a pump P4 to storage tank CT2 from which it can be used for any purpose such as agriculture, gardening, ground water recharge, cooling etc. It is not necessary to have the storage tank CT2 if the treated water is directly discharged to a receiving stream or reservoir. The tank CT2 is needed if the treated water needs to be stored for recycling.

Thus in one embodiment the treatment process provides a very efficient and cost-effective tertiary treatment for raw sewage through three rapid and highly optimized chemical reactions. The treatment process is completely chemical in nature and destroys all odor-causing bacteria and pathogens. The raw sewage undergoes rapid change in its chemistry and through flocculation, adsorption and precipitation reactions the raw sewage is transformed into clear, odor-free, bacteria-free recyclable water. All valuable nutrients such as phosphorus, nitrogen, potassium and sulphur are sequestered in the odor-free, bacteria-free sludge which can be used as a fertilizer. In one embodiment the entire process is a continuous batch treatment system.

Although the present invention has been described with reference to certain embodiments, the invention is not limited to the embodiments. Various other embodiments of the invention will be apparent to a person skilled in the art or follow from routine experimentation.

What is claimed is:

1. A treatment system for treating sewage comprising:
a. at least one first reaction tank for elevating pH of the sewage to more than 10.0;
b. a second reaction tank for inducing rapid flocculation of the output from the first reaction tank to remove all suspended solids, insoluble BOD, insoluble chemical complexes by using polymeric flocculent and/or coagulant;
c. a solid separator separates the flocculated waste matter and solids discharged from the second reaction tank;
d. an upflow reactor or a filter for adsorbing dissolved organic compounds including gases and/or to moderate the pH of the contents from the solid separator; and
e. a third reaction tank to reduce the pH of the contents from the upflow reactor or the filter to acceptable levels of 8.5 or less;
to obtain a treated sewage.

2. The system of claim 1, wherein pH of the sewage is elevated by use of calcium hydroxide (hydrated lime).

3. The system of claim 1, wherein the reducing of the pH to acceptable levels of 8.5 or less is by using aluminum sulphate (alum).

4. The system of claim 1, wherein the reaction tanks consist of at least one mixer.

5. The system of claim 1, wherein the upflow or the filter contains activated carbon and/or zeolite filter.

6. The system of claim 1, wherein the activated carbon is derived from such sources as coconut shell or bitumen coal carbon.

7. A method of treating sewage comprising:
a. increasing pH of the sewage to more than 10
b. flocculating the sewage by adding polymeric flocculent and/or coagulant;
c. separating the flocculated matter and solids from the above;
d. adsorbing excess organic compounds and/or moderating the pH of the contents by using an upflow reactor or a filter; and
e. reducing the pH of the above to acceptable levels of 8.5 or less
to obtain a treated sewage.

8. The method of claim 7, wherein the increasing pH of the sewage is by adding calcium hydroxide (hydrated lime).

9. The method of claim 7, wherein the reducing the pH to acceptable level of 8.5 or less is by adding aluminum sulphate (alum).

10. The method of claim 7, wherein the sewage is homogenized before increasing the pH.

11. The method of claim 7, wherein the upflow reactor or the filter contains activated carbon and/or zeolite filter.

12. The method of claim 7, wherein the media is activated carbon filter or a combination of activated carbon and zeolite, and the activated carbon is derived from either coconut shell or bitumen coal carbon.

13. The method of claim 7, wherein the treated sewage is water.

14. A treatment process for treating sewage comprising:
a. increasing pH of the sewage to more than 10;
b. inducing rapid flocculation by adding polymeric flocculent and/or coagulant and removing all suspended solids, insoluble BOD and insoluble chemical complexes;
c. separating the flocculated matter and solids from the above;
d. adsorbing excess organic compounds and/or moderating the pH of the contents by using an upflow reactor or a filter; and
e. reducing the pH of the above to acceptable levels of 8.5 or less;
to obtain a treated sewage.
